(19) United States
(12) Patent Application Publication
(10) Pub. No.: US 2021/0030210 A1
(43) Pub. Date: Feb. 4, 2021

(54) STACKABLE COOKWARE

(71) Applicant: M/s. Stovekraft Limited, Kamataka (IN)

(72) Inventor: Lakshmi Naga Venkata Sudarshana Mukharji Pothakamuri, Karnataka (IN)

(73) Assignee: M/s. Stovekraft Limited, Karnataka (IN)

(21) Appl. No.: 16/566,941

(22) Filed: Sep. 11, 2019

(30) Foreign Application Priority Data
Jul. 30, 2019 (IN) 201941030650

(51) Int. Cl. A47J 45/06; A47J 27/12

(52) U.S. Cl. CPC A47J 45/061; A47J 27/12

(57) ABSTRACT

A stackable cookware with a novel feature of an upward projection locking mechanism. The upward projection is close to the upward wall of the vessels and this design helps secure the lid of cookware articles during their storage and transport. The upward projection feature also helps in stacking of the containers and to get a grip while moving these stacked containers. Upward projection is designed to securely fit into the slot depression of the bottom profile of the stackable handle to lock the vessels together, thus helping in the stacking of the containers. In addition to Dutch ovens, this locking mechanism may also be extended to other types of containers, such as saucepans and frying pans.

### STATEMENT OF RELATED APPLICATIONS

This patent application is the non-provisional of and claims priority on and the benefit of Indian application no. 201941030650 having a filing date of 30 Jul. 2019.

### BACKGROUND OF THE INVENTION

Consumers generally tend to use multiple cookware that comes in various sizes. Storing such cookware becomes cumbersome and inconvenient. Certain prior arts disclose cooking vessels with removable handles for saving space. However, such removable handles are easily lost or damaged and can complicate the use of multiple burners or heat sources for cooking.

Another existing problem with stacking multiple vessels is that as the stack pile grows, the stacked vessels tend to skew or tilt toward one direction thereby making the stack unstable.

Cookware may be stacked such that a smaller cookware vessel is placed inside the larger cookware vessel, with the lids of the cookware vessels placed on top of the stack. Some cooking vessels have handles on both the sides of the vessel and will be of varying length. The notch parts on the handles are sharp, unsafe and would also damage other vessels. As a result, storage and organization of cookware may consume space and may be difficult to store in certain locations, such as kitchen cabinets.

The present invention aims to overcome the above problems of stacking and storing cookware. The present invention relates to stackable cookware including a plurality of vessels. The novel feature of this invention is the upward projection locking mechanism of the handles. The upward projection is close to the upward wall of the vessels and this design helps secure the lid of cookware articles during their storage and transport. The upward projection feature also helps in the stacking of the containers and to get a grip while moving these stacked containers. The upward projection is designed to securely fit into the curved slot of the bottom profile of the handle to lock the vessels together, thus helping in stacking of the containers. Though the upward projection is shown and described with respect to Dutch oven type containers, the upward projection locking mechanism can also be extended to other types of containers, for example, saucepans and frying pans.

### TECHNICAL FIELD

The present invention relates to a stackable cookware and more specifically it relates to Dutch ovens or casseroles or deep pots. More particularly present invention discloses stackable cookware with an upward projection locking mechanism that provides a better grip against the thumb while carrying the stacked containers.

### PRIOR ART

AU2013200083A1 titled “Stackable Cooking Pans and Lids” discloses a set of stackable or nestable cooking pans with handles and lids where each pan is progressively smaller and where the smaller pan can fit into the next larger pan. The external surface of the base of the smaller cooking pan rests flat on the internal surface of the base of the next larger cooking pans and the recess of the handle of the smaller one of the cooking pans clears the level portion of the upper rim edge of the next larger one of the cooking pans of the set. This invention also relates to sets of stackable or nestable bakeware.

AU759484B2 titled “Cookware lid and handle assemblies” discloses improved features in pots and casseroles for audibly indicating the creation of a pressure seal, for venting the cookware, and for supporting the cookware lid when not in use. The finger protectors are mounted to the lid at diametrically opposed locations, finger protectors overlie the side handles, the unique mating relationship between the upper face and the lower face of handles, cookware which has a water seal and whistle indicator, finger protectors fit within a handle aperture in the side handle and not stackable.

EP0687154B1 titled “Set of stackable pots” discloses a set of pots that are supported on the upper edge of the underlying pot by means of its diametrically opposed handles, stackable pans each with decreasing size such that smaller pan completely fits into next larger pan, stackable lids are placed inside the pots.

EP1876935B1 titled “Stackable cooking utensils and adapted cover and accessory” discloses stackable cookware and handle. The handle is equipped with at least one pin and one housing which is at least partially defined by a hollow zone in the handle, such that the utensils can be securely stacked.

EP1959804B1 titled “Handle for stackable item of kitchen equipment and set of such handles and items of equipment” discloses a handle for cookware with a locking projection that is adapted to engage with a reception zone provided on another handle of another cooking utensil.

### BRIEF SUMMARY OF THE INVENTION

The present invention relates to a stackable cookware and more specifically it relates to Dutch ovens or casseroles or deep pots.

In accordance with one or more embodiments of the present disclosure, the stackable cookware may include a plurality of pots or vessels which may be stacked within one another.

In another embodiment of the disclosure, the stackable cookware may also optionally include a plurality of accompanying lids.

In another embodiment, the stackable cookware may be of varying size.

The present invention relates to a stackable cookware comprising a vessel having a closed bottom surface, an open top, a sidewall, said sidewall extending upwardly from a bottom surface of the said vessel to the vessel rim, a pair of stackable handles placed diagonally opposite to each other, wherein the said handle has an upward projection at the top surface of the handle and a slot depression at the bottom surface of the handle to enable locking, said handles may include an open hole or aperture to enable hanging the cookware, and an optional lid to rest upon said vessel rim, said lid having a knob on its top. The knob can be of various shapes such as round, triangular, square, rectangle, octagon, or hexagon.

The stackable cookware set may include a first larger vessel with a pair of first stackable handles, a second smaller vessel with a second pair of stackable handles, and a third smallest vessel with a pair of third stackable handles such that the first larger vessel is the outermost vessel in the stack and the third smallest vessel is the innermost vessel in the stack, each vessel having a progressively smaller diameter and height such that the smaller vessel fits within the next larger vessel. Each vessel has a corresponding optional lid which may include a knob on its top surface. The lids may be positioned on top of any one of the vessel rim or may be specific to specific vessels. Each cookware article has a pair of stackable handles placed diagonally opposite to each other, each extending from the upper sidewall of the vessel. The cookware has sidewalls extending upwardly from a bottom surface of the vessel to a vessel rim. The cookware may be aligned and placed within the cavity of another cookware unit for stacking, accommodating a plurality of vessels. The cookware is designed in such a way that the smaller one of the cookware vessel is stacked within a next larger one of the cookware vessel.

During stacking of the cookware, the upward projection of the handles prevents the external surface of the base or bottom surface of one smaller vessel from resting flat on the internal surface of the base of a second larger vessel, thus preventing damage to the inner coating of the vessels. This arrangement also leaves considerable space or gap between the bases of two consecutive vessels. This said space can be further utilized to store a lid thereby saving space. The cookware is held in a stable stacked position using the handles.

Another embodiment of the present disclosure shows a stackable cookware pot or vessel with a pair of stackable handles. The stackable cookware comprises a bottom surface, vertical sidewalls extending upwardly from a bottom surface of the vessel to a vessel rim, an optional lid and a pair of stackable handles. The cookware has a pair of stackable handles placed diagonally opposite to each other. The handles are attached to the vessel sidewalls with one or more metallic inserts. The handles allow for the vessels to be gripped or carried and also accommodate stacking.

One embodiment of the present disclosure illustrates the upward projection locking mechanism of the stackable handles. The handles may be positioned so as to stack on top of each other in a stacked handle configuration. The handle of each cookware is comprised of an upward projection at the top surface of the handle and a slot depression in the bottom surface of the handle. The upward projection at the top surface of the handle is close to the upward wall of the vessel, such that it helps to secure the lid during storage and transport. The upward projection in the handle of a second vessel locks in with the slot depression in the handle of the first vessel. The upward projection also helps to get a better grip against the thumb while carrying the stacked containers. The stackable handles may be of similar length and design irrespective of the cookware size, thereby being cost-effective.

### BRIEF DESCRIPTION OF THE DRAWINGS

FIG. 1 depicts a set of stackable cookware and lids.

FIG. 2 shows a stackable cookware pot with handles.

FIG. 3 depicts another embodiment of a set of stackable cookware with handles in accordance with one or more embodiments of the present disclosure.

FIG. 4 illustrates the upward projection locking mechanism of the handles.

FIG. 5 illustrates an upward projection at the top surface of the cookware handle.

FIG. 6 shows a depression at the bottom surface of the cookware handle.

### DETAILED DESCRIPTION OF THE PREFERRED EMBODIMENTS

For the purpose of promoting an understanding of the invention, reference will now be made to the embodiments illustrated in the Figures and specific language will be used to describe them. It will nevertheless be understood that no limitation of the scope of the invention is thereby intended. It will be understood by those skilled in the art that the foregoing general description and the following detailed description are exemplary and explanatory of the invention and are not intended to be restrictive thereof.

Such alterations and further modifications in the illustrated system, and such further applications of the principles of the invention as would normally occur to those skilled in the art are to be construed as being within the scope of the present invention.

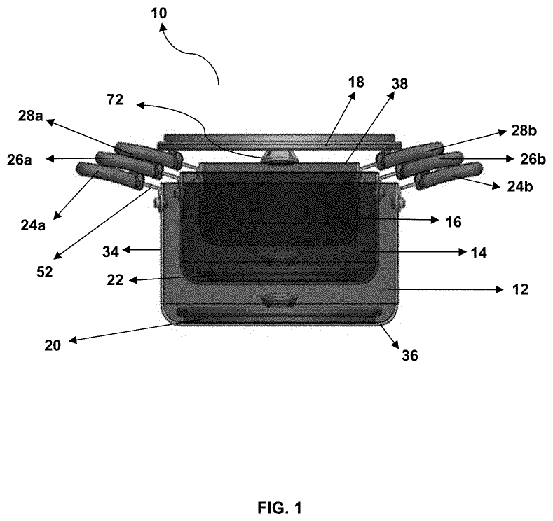

FIG. 1 depicts a stackable cookware 10 in accordance with one or more embodiments of the present disclosure. The stackable cookware may include a plurality of pots or vessels 12, 14, 16. The stackable cookware may also optionally include a plurality of accompanying lids 18, 20, 22. In the illustrated example, the stackable cookware set 10 may include a first larger vessel 12 with a pair of first stackable handles 24a, 24b, a second smaller vessel 14 with a second pair of stackable handles 26a, 26b, and a third smallest vessel 16 with a pair of third stackable handles 28a, 28b wherein the first larger vessel is the outermost vessel in the stack and the third smallest vessel is the innermost vessel in the stack, each vessel having a progressively smaller diameter and height such that the smaller vessel fits within the next larger vessel.

Each vessel has an optional lid which may include a knob 72 on its top surface. The knob can be of various shapes such as round, triangular, square, rectangle, octagon, or hexagon. The lids 18, 20, 22 may be positioned on top of any one of the vessel rim 38 or may be specific to specific vessels. Each cookware article has a pair of stackable handles 24a 24b, 26a, 26b, 28a, 28b, placed diagonally opposite to each other, extending from the upper sidewall of the vessel. The handle of each cookware is comprised of an upward projection 32 at the top surface of the handle and a slot depression 42 in the bottom surface of the handle. The upward projection 32 in the handle of a first vessel locks in with the slot depression 42 in the handle of the second smaller vessel, to enable locking 50, as shown in FIG. 4.

The cookware has a sidewall 34 extending upwardly from a bottom surface 36 of the vessel to a vessel rim. The cookware may be aligned and inserted into the cavity of another cookware unit for stacking, accommodating a plurality of vessels. The cookware is designed in such a way that the smaller one of the cookware vessel is stacked within a next larger one of the cookware vessel.

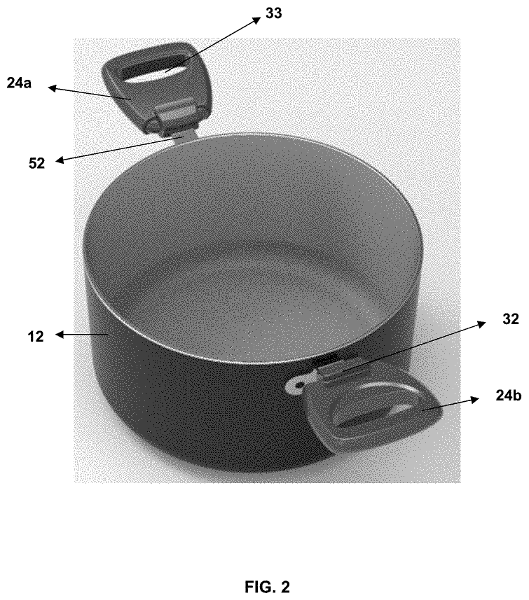

FIG. 2 shows a stackable cookware pot with handles. The stackable cookware 12 comprises a bottom surface, vertical sidewalls extending upwardly from a bottom surface 36 of the vessel, a corresponding optional lid and a pair of stackable handles 24a, 24b placed diagonally opposite to each other. The handles are attached to the vessel sidewalls with one or more metallic insert 52. The metallic insert is preferably a stainless steel insert. The handle also has an open hole or aperture 33 to enable hanging the cookware.

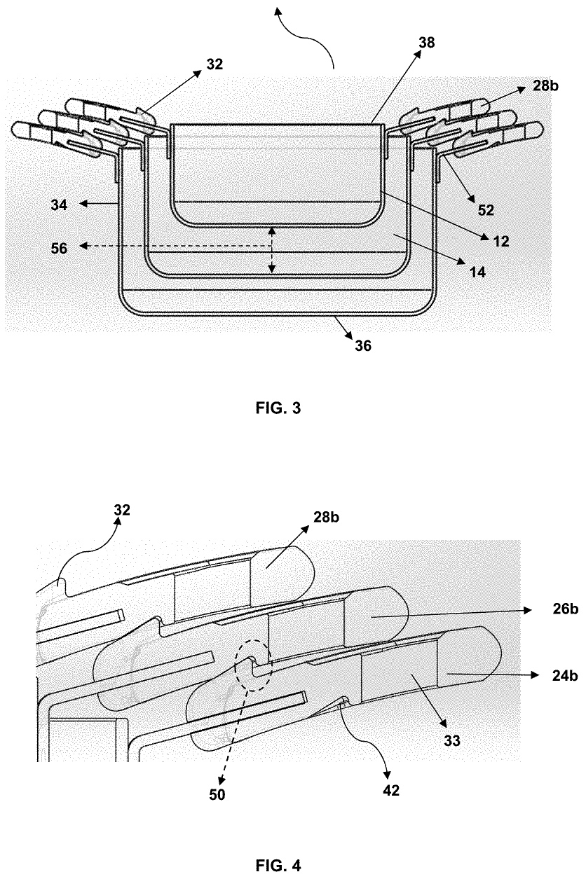

FIG. 3 depicts another embodiment of a set of stackable cookware 10 with stackable handles 24, 26, 28 in accordance with one or more embodiments of the present disclosure as illustrated in FIG. 1. The handles allow for the vessels to be gripped or carried and also accommodate stacking. During stacking of the cookware, the upward projection 32 of the handles prevents the external surface of the base or bottom surface of one smaller vessel 16 from resting flat on the internal surface of the base of a second larger vessel 14, thus preventing damage to the inner coating of the vessels. This arrangement also leaves considerable space or gap 56 between the bases of two consecutive vessels. This said space can be further utilized to store a lid, if any, thereby saving space. The cookware is held in a stable stacked position using the handles.

FIG. 4 illustrates the upward projection locking mechanism of the stackable handles. The handles may be positioned so as to stack on top of each other in a stacked handle configuration. The handle of each cookware is comprised of an upward projection 32 at the top surface of the handle and a slot depression 42 in the bottom surface of the handle. The upward projection 32 in the handle of a first vessel locks in 50 with the slot depression 42 in the handle of the second smaller vessel, to enable locking. The upward projection also helps to get a better grip against the thumb while carrying the stacked containers. The stackable handles may be of similar length and design irrespective of the cookware size, thereby being cost-effective.

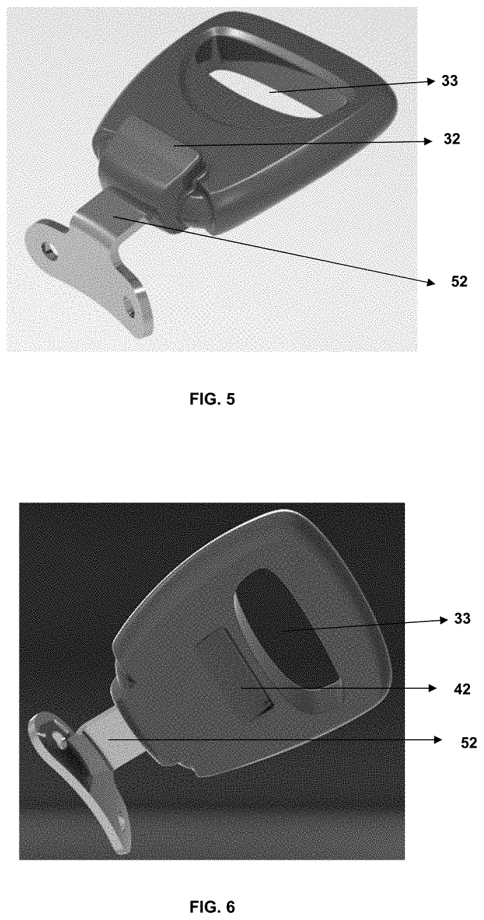

FIG. 5 illustrates an upward projection at the top surface of the cookware handle. The upward projection 32 at the top surface of the handle is close to the upward wall of the vessel, such that it helps to secure the lid during storage and transport. The upward projection is designed to securely fit into the slot of the bottom profile of the handle to lock the vessels together. The upward projection also helps to get a better grip against the thumb while carrying the stacked cookware set 10. The handle also has an open hole or aperture 33 to enable hanging the cookware.

FIG. 6 illustrates a depression at the bottom surface of the cookware handle. The handles of each cookware article have a slot depression 42 in the bottom surface of the handle. The upward projection in the handle of a first vessel locks in with the slot depression in the handle of the second smaller vessel to enable locking.

What is claimed is:

1. A stackable cookware 10 comprising:
i) a vessel 12 having a closed bottom surface 36, an open top, and a sidewall 34, said sidewall extending upwardly from a bottom surface of the said vessel to the vessel rim 38;
ii) a pair of stackable handles 24a 24b placed diagonally opposite to each other, wherein the said handle has an upward projection 32 at the top surface of the handle and a curved slot depression 42 at the bottom surface of the handle to enable locking 50; and
iii) optionally including a lid 18 to rest upon said vessel rim, said lid having a knob 72 on its top.

2. The stackable cookware 10 as claimed in claim 1, wherein upward projection 32 on a top surface of a handle is close to the upward wall of the said vessel 12.

3. The stackable cookware 10 as claimed in claim 1, wherein said stackable handle 24 is attached to the sidewall of said vessel 12 using metallic insert 52.

4. The stackable cookware 10 as claimed in claim 1, wherein the stackable handle 24 may be of similar length and design irrespective of the cookware size.

5. The stackable cookware 10 as claimed in claim 1, wherein said upward projection 32 of the side handle can also be extended to other types of vessels such as saucepans, and frying pans.

6. The stackable cookware 10 as claimed in claim 1, wherein the stackable handles 24a 24b include an open hole 33.

7. The stackable cookware 10 as claimed in claim 1, wherein the knob 72 can be of various shapes.

8. A stackable cookware set 10 comprising a plurality of vessels 12, 14, 16, a pair of stackable handles 24a 24b, 26a, 26b, 28a, 28b placed diagonally opposite to each other, said set including optional lids 18, 20, 22, wherein a first larger vessel 12 with a pair of first stackable handles 24a, 24b, a second smaller vessel 14 with a second pair of stackable handles 26a, 26b, a third smallest vessel 16 with a pair of third stackable handles 28a, 28b such that the first larger vessel is the outermost vessel in the stack and the third smallest vessel is the innermost vessel in the stack, each vessel having a progressively smaller diameter and height such that the smaller vessel fits within the next larger vessel, the said handle has an upward projection 32 at the top surface of the handle and a slot depression 42 at the bottom surface of the handle such that the said upward projection in the handle of a first vessel fits and locks in 50 with the slot depression in the handle of the second vessel.

9. The stackable cookware 10 as claimed in claim 8, wherein upward projection 32 on a top surface of a handle is close to the upward wall of the said vessels.

10. The stackable cookware 10 as claimed in claim 8, wherein said stackable handles are attached to the sidewall of said vessel using metallic inserts 52.

11. The stackable cookware 10 as claimed in claim 8, wherein the upward projection 32 of the handles 24a 24b, 26a, 26b, 28a, 28b prevents the external surface of the base of one smaller vessel from resting flat on the internal surface of the base of a second larger vessel.

12. The stackable cookware 10 as claimed in claim 8, wherein a space 56 between the bases of two consecutive vessels can be further utilized to store a lid 18, 20, 22.

13. The stackable cookware 10 as claimed in claim 8, wherein the stackable handles may be of similar length and design irrespective of the cookware size.

14. The stackable cookware 10 as claimed in claim 8, wherein said upward projection 32 of the side handle can also be extended to other types of vessels such as saucepans, and frying pans.

15. The stackable cookware 10 as claimed in claim 8, wherein the stackable handles 24a 24b, 26a, 26b, 28a, 28b include an open hole 33.

16. The stackable cookware 10 as claimed in claim 8, wherein the knob 72 can be of various shapes.
